(19) United States
(12) Patent Application Publication
(10) Pub. No.: US 2012/0175885 A1
(43) Pub. Date: Jul. 12, 2012

(54) Rotating Impeller Systems and Methods of Using Same

(75) Inventor: Adam Peer, Sherman, TX (US)

(73) Assignee: Peese, Inc., Sherman, TX (US)

(21) Appl. No.: 13/310,180

(22) Filed: Dec. 2, 2011

(51) Int. Cl. H02K 7/18; F04B 17/00; F01D 25/16

(52) U.S. Cl. 290/1 A; 415/229; 290/52; 417/423.1

(57) ABSTRACT

The present disclosure provides rotating impeller systems comprising a shaft with a plurality of blades attached to its inner wall. In motor applications, the shaft serves as the electrical and mechanical elements of a pump or vacuum system. In particular, the shaft rotates when energized, and the attached blades create a driving force. The rotating impeller systems of the present disclosure may be used in generator applications, where the shaft serves as the rotor and a housing serves as the stator. Generator applications include wind energy or hydroelectricity.

### TECHNICAL FIELD

The present disclosure generally relates to rotating impeller systems and methods of using same, and particularly relates to rotating impeller systems that may be used as a generator and/or motor in various applications.

### BACKGROUND OF THE INVENTION

Prior art pumps, such as pump 10 shown in FIG. 1, typically require separate components to effectively operate: a motor 12 that converts electrical energy to mechanical energy, which is translated through a solid center shaft coupled to blades or impellers in housing 14, thereby causing blades or impellers to rotate and create a driving force. Consequently, the driving force from the rotation of the blades or impellers causes fluid to flow from the intake 16 to the outlet 18. The reverse conversion of mechanical energy into electrical energy is done with generators having similar components where a mechanical force, such as wind, water, combustion, or other forces, rotate the impellers that are coupled to a separate electrical component that causes electrical current to flow through an external electrical circuit.

These conventional systems, which require separate electrical and mechanical components, introduce operational inefficiency to the system in the form of mechanical drag, electrical loss, undue complexity and weight, and the like. These multi-component systems increase friction, thereby further adding to inefficiency. Moreover, additional components expose the systems to more wear and tear, decreasing the operational lifetime of these systems, which increases costs in replacement parts and time.

### BRIEF SUMMARY OF THE INVENTION

According to one aspect of the present disclosure, there is provided a motor comprising: a bearing housing member; a-shaft member configured to rotate when energized; a plurality of blade members attached to the inner wall of said shaft member; and a plurality of bearing members mounted between at least one end of said shaft member and said bearing housing member to allow said shaft member to rotate with respect to said bearing housing member.

In one embodiment, the motor further comprises a thrust member attached to an input of said shaft member; wherein said thrust member comprises an input having a first diameter and an output having a second diameter, where said first diameter is greater than said second diameter. In another embodiment, the shaft member comprises an input having a first diameter and an output having a second diameter, where said first diameter differs from said second diameter. In yet another embodiment, the plurality of bearing members are selected from the group consisting of plain bearings, rolling element bearings, jewel bearings, fluid bearings, magnetic bearings and flexure bearings.

According to another aspect of the present disclosure, there is provided a system comprising a wind generator. The wind generator comprises a housing member; a shaft member; a plurality of blade members attached to the inner wall of said shaft member; said plurality of blade members configured to rotate said shaft member when acted on by a sufficient amount of wind force; a plurality of bearing members mounted between at least one end of said shaft member and said bearing housing member; a magnetic mechanism attached to the outer wall of said shaft member, said magnetic mechanism configured to generate a magnetic field; and a stator surrounding at least a portion of said magnetic field.

In one embodiment, the wind generator further comprises an induction cone member attached to an input of said shaft member; wherein said induction cone member comprises an input having a first diameter and an output having a second diameter, where said first diameter is greater than said second diameter. In another embodiment, the wind generator further comprises a pole member attached to at least said wind generator, said pole member configured for 360 degrees rotation by said wind generator. In another embodiment, the wind generator further comprises a tail member attached to said wind generator, said tail member configured to facilitate movement of said wind generator according to the direction of the wind.

In another embodiment, the magnetic mechanism comprises at least one permanent magnet. Alternatively, the magnetic mechanism comprises at least one electromagnet. In yet another embodiment, the system comprises a plurality of said wind generators electrically coupled to a transformer for electrical distribution.

According to another aspect of the present disclosure, there is provided a system comprising a hydro-generator. The hydro-generator comprises a housing member; a shaft member; a plurality of blade members attached to the inner wall of said shaft member; said plurality of blade members configured to rotate said shaft member when acted on by a sufficient amount of water force; a plurality of bearing members mounted between at least one end of said shaft member and said bearing housing member: a buoyant member attached to said shaft member, said buoyant member configured to maintain said hydro generator within a desired depth range and allow said hydro generator member to rotate 360 degrees; a magnetic mechanism attached to the outer wall of said shaft member, said magnetic mechanism configured to generate a magnetic field; and a stator surrounding at least a portion of said magnetic field.

In one embodiment, the magnetic mechanism comprises at least one permanent magnet. Alternatively, the magnetic mechanism comprises at least one electromagnet. In another embodiment, the system further comprises a plurality of said hydro-generators electrically coupled to a transformer for electrical distribution.

According to another aspect of the present disclosure, there is provided a generator system comprising: a mechanical element configured to accept a mechanical action; and an electrical element configured to translate said mechanical action into electrical energy; wherein said mechanical element and electrical element comprise a single component.

In one embodiment, the mechanical element is axially aligned with said electrical element. In another embodiment, the single component is configured to rotate in response to said accepting a mechanical action. In another embodiment, said mechanical element is circumferentially inside of said electrical element. In another embodiment, said mechanical element comprises a plurality of blade members.

In yet another embodiment, the system further comprises an induction component, wherein said induction component is configured to amplify fluid entering said single component. In another embodiment, said induction component comprises a first diameter and a second diameter, wherein said first diameter is greater than said second diameter.

According to another aspect of the present disclosure, there is provided a motor system comprising a single component configured to rotate and produce a driving force when energized, wherein said single component comprises a mechanical element configured to produce said driving force when rotated; and an electrical element configured to energize said mechanical element using electrical energy.

In one embodiment, said mechanical element is axially aligned with said electrical element. In another embodiment, said mechanical element is circumferentially inside of said electrical element. In another embodiment, said mechanical element comprises a plurality of blade members.

In another embodiment, the system further comprises a thrust component, wherein said thrust component is configured to amplify fluid exiting said single component. In yet another embodiment, said thrust component comprises a first diameter and a second diameter, wherein said first diameter is greater than said second diameter. In another embodiment, an input of said thrust component comprises said first diameter and an output of said thrust component comprises said second diameter. In another embodiment, the input of said thrust component is coupled to an output of said single component.

In another embodiment, said single component is configured to amplify fluid exiting said single component, said amplification achieved by said electrical element comprising a first diameter and a second diameter, wherein said first diameter is greater than said second diameter. In another embodiment, an input of said single component comprises said first diameter and an output of said single component comprises said second diameter. In yet another embodiment, the system further comprises a plurality of said single component, wherein at least an output of one single component is coupled to an input of another single component.

The foregoing has outlined rather broadly the features and technical advantages of the embodiments present disclosure in order that the detailed description of these embodiments that follows may be better understood. Additional features and advantages of the embodiments of the present disclosure will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a perspective view of a prior art pump;

FIG. 2A is a front view of a first embodiment of the rotating impeller system according to the present disclosure;

FIG. 2B is a side view of the first embodiment of the rotating impeller system according to the present disclosure ;

FIG. 2C is a rear view of the first embodiment of the rotating impeller system according to the present disclosure;

FIG. 3A is a front view of an exemplary configuration of the bearings between the shaft and the bearing housing of a second embodiment according to the present disclosure;

FIG. 3B is a side view of the exemplary configuration of the bearings between the shaft bearing housing of FIG. 3A;

FIG. 4A is a side cross sectional view of an exemplary configuration of the shaft according to one aspect the present disclosure;

FIG. 4B is a front view of the exemplary configuration of the shaft of FIG. 4A;

FIG. 5A is a side view of a third embodiment of the rotating impeller system according to the present disclosure;

FIG. 5B is a front view of the third embodiment of the rotating impeller system according to the present disclosure; and

FIG. 6 is a perspective view of the rotating impeller system according to the present disclosure being used to harvest wind energy.

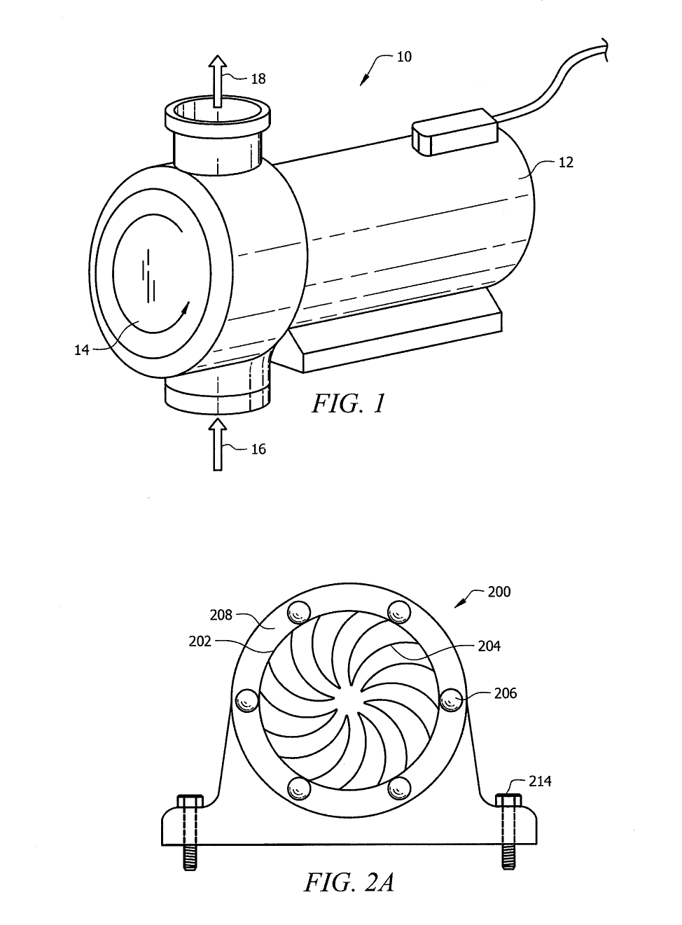

### DETAILED DESCRIPTION OF THE INVENTION

The present disclosure relates to rotating impeller systems that provide a single component capable of performing both mechanical and electrical actions and translating between the two, where multiple components are typically required. The single component provides a mechanism for accepting or providing a driving force and a mechanism for translating between the driving force and electricity (whether the electricity is in the form of an input signal or an output signal).

The rotating impeller system of the present disclosure replaces the input shaft configuration of conventional systems. For instance, traditional pumps have a motor or electrical element and a separate driving force component. The motor or electrical element often includes an input shaft that rotates when energized. This input shaft, however, does not produce any driving force when it is rotated. Rather, the input shaft is often coupled to a separate mechanical element, e.g., impellers or blades, and the rotation of the input shaft rotates the blades. It is the rotation of the blades that produce a driving force or thrust to move fluid from one location to another. The rotating impeller system of the present disclosure employs a single component that provides both the electrical and mechanical elements. When the rotating impeller system of the present disclosure serves as a pump, the rotating impeller system of the present disclosure replaces the input shaft configuration with a motor that allows fluid (e.g., air or liquid) to flow through the motor itself, which is achieved with an input shaft that comprises a hollow cylinder with blades or impellers attached to the inner wall of the cylinder. Accordingly, the present disclosure provides a single component serving as both a mechanical element for providing a driving force when rotated and an electrical element for translating electricity to rotate the single component.

In conventional generator configurations, such as a wind mill, the mechanical element that accepts a driving force or mechanical action, i.e., blades of the wind mill, is usually attached to an input shaft that is coupled, usually through gears, to a separate electrical element, i.e., rotor of a generator. As discussed above, rotating impeller system of the present disclosure employs a single component that provides the mechanical and electrical elements of conventional systems. When the rotating impeller system of the present disclosure serves as a generator, the input shaft serves as both the mechanical element accepting the driving force from the wind and the electrical element (e.g., rotor) that translates the rotation of the mechanical element into electricity. For example, in one embodiment, the hollow cylinder further comprises permanent magnets or electromagnets are attached to the outside of the hollow cylinder. The rotating impeller system further comprises a stator (e.g., armature windings) surrounding the permanent magnets or electromagnets. As the hollow cylinder input rotates in response to the wind acting on the blades or impellers attached to the inner wall, the moving magnetic field from the permanent magnets or electromagnets produce electricity in the stator. Accordingly, the present disclosure provides a single component serving as both a mechanical mechanism for accepting a driving force and an electrical mechanism for translating the work from the driving force to electricity.

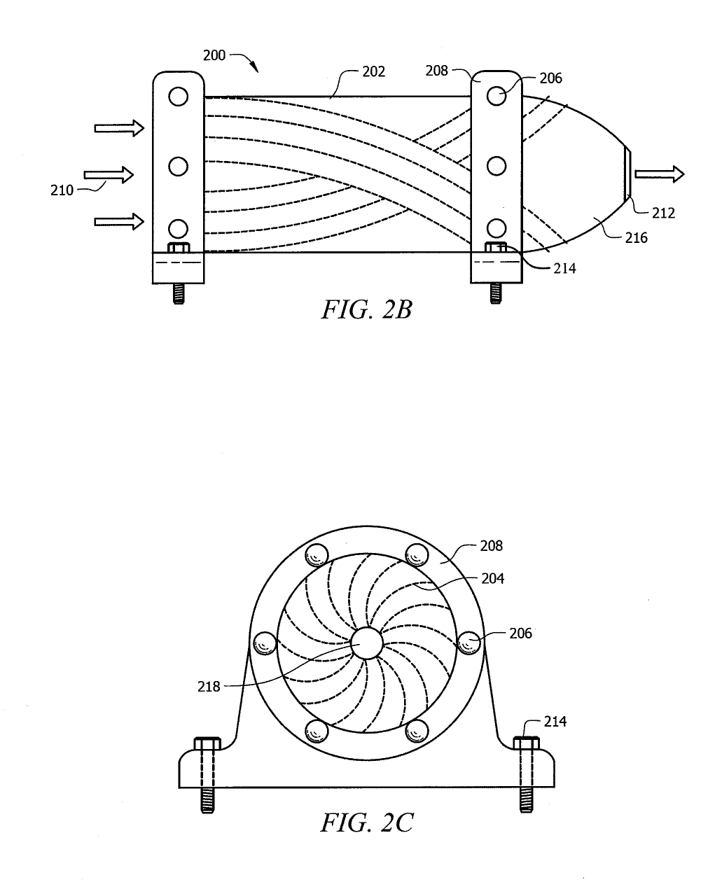

FIG. 2A illustrates an embodiment of rotating impeller system 200. System 200 comprises shaft 202 where plurality of blades 204 are attached to the wall of shaft 202. Blades 204 may be attached to shaft 202 or may be molded into a portion of the wall of shaft 202. In one embodiment, blades 204 are removably attached to shaft 202. For instance, one or more removable blade inserts can be slid into the interior of shaft 202 and snapped onto shaft 202 or attached by other means. Blades 204 may be made of materials suitable for the particular application, such as various types of metals and plastics known in the art. Blades 204 may be in any configuration, shape, style, or design that allows blades 204 to accept the intended force or provide the desired force according to the particular application. For instance, in one embodiment, if the rotating impeller system of the present disclosure is intended to be used as a pump to move viscous fluid, blades 204 may have a greater thickness than a rotating impeller system that is intended to be used as a pump to move air. In another embodiment, if the rotating impeller system of the present disclosure is intended to be used as a mulcher or shredder, at least one blade with a sharp edge may be used. In embodiments where blades 204 are removably attached to shaft 202, a rotating impeller system can include several blade inserts, each with a different configuration or design for different applications. In certain embodiments, the removability of the blade inserts allow for a quick and easy modification of rotating impeller system for use in various applications.

Referring to FIGS. 2A, 2B, 2C, shaft 202 may rotate freely with respect to bearing housing 208 via a plurality of bearings adjacent the two ends that are contained in bearing housing 208. As shown, shaft 202 and bearing housing 208 are mechanically coupled to one another via the bearings inside bearing housing 208. According to the preferred embodiment, shaft 202 is otherwise not in contact with other components of bearing housing 208.

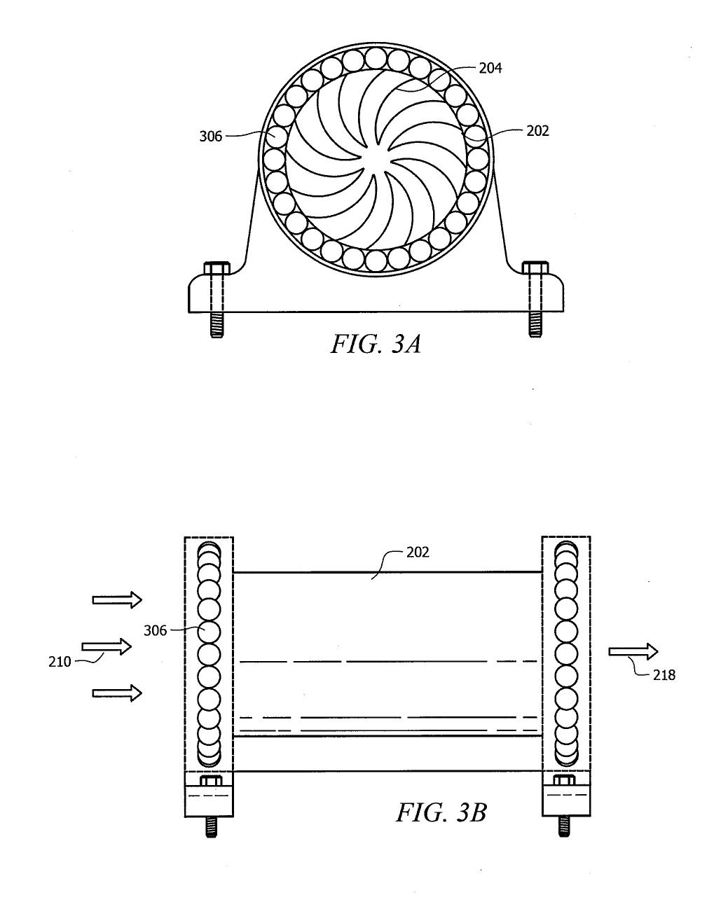

FIGS. 2A, 2B, and 2C show the front, side, and rear view, respectively, of shaft 202 mechanically coupled to bearing housing 208 through the bearings inside bearing housing 208. Referring to FIGS. 3A and 3B, in one embodiment, shaft 202 is mechanically coupled to bearing housing 208 via bearings 306. As shown, a plurality of ball bearings 306 surround the ends of shaft 202. Bearing housing 208 holds ball bearings 306, which allow shaft 202 to freely rotate with respect to bearing housing 208. In another embodiment, other suitable bearings may also be used. Suitable bearings include plain bearings, rolling element bearings, jewel bearings, fluid bearings, magnetic bearings, flexure bearings or any other type of bearings or materials that allow shaft 202 to freely rotate while mounted to bearing housing 208. Referring to FIGS. 2A, 2B, and 2C, rotating impeller system 200 may also include bolts 214 that allow the rotating impeller system 200 to be fixed or attached to any desired surface.

In one embodiment, the rotating impeller system 200 functions as a motor where shaft 202 is rotated when energized by an external electric source, thereby causing the attached blades 204 to correspondingly rotate. The rotation of the blades 204 produces a driving force that draws fluid from the surrounding environment into the input 210 through shaft 202, and the fluid exits out through output 212. Unlike conventional motors, the rotation of the motor or shaft 202 results in a driving force of fluid (e.g., air or water) without the use of a separate mechanical component. As discussed above, rotating impeller system 200 replaces the conventional input shaft configuration. The rotating impeller system 200 directs movement of air of fluids through the electrical element, i.e., the motor itself. That is, shaft 202 performs the electrical and mechanical functions of a conventional pump, thereby eliminating a component from conventional systems and providing various efficiency benefits. Accordingly, the present disclosure provides a single component serving as both a mechanical mechanism for providing a driving force when rotated and an electrical mechanism for translating electricity to rotate the single component.

Referring to FIG. 3B, rotating impeller system 200 preferably has input 210 and output 218, where the diameter of input 210 is substantially the same as the diameter of output 218. Input 210 and output 218 are preferably axially aligned. Referring to FIGS. 3A and 3B, the rotation of blades 204 provides a driving force that can transfer fluid from input 210 to output 218. The fluid exiting at output 218 has a certain amount of force. This force of the exiting fluid can be further amplified in another embodiment comprising a thrust component as described further in detail below.

Referring to FIGS. 2A and 2B, in another embodiment, impeller rotating system 200 can further comprise a thrust component, such as compression nozzle 216, which can increase the force provided by rotating impeller system 200. The input of compression nozzle 216 is preferably coupled to the output of motor or shaft 202. In this embodiment, rotating impeller system 200 preferably has input 210 and output 212, which is the output of compression nozzle 216. The diameter of input 210 is preferably larger than the diameter of output 212. Input 210 and output 212 are preferably axially aligned. The force of the fluid traveling through motor or shaft 202 can be amplified by compression nozzle 216. Referring to FIGS. 2A and 2B, in one embodiment, compression nozzle 216 can amplify the force of the exiting fluid through its generally conical shape. The diameter of the thrust component 216 tapers or gets smaller toward the output 212. The increase in force is achieved by the narrowing of the diameter of the thrust component 216. The generally conical shape of thrust component 216 compresses the fluid that exits shaft 202 and gets pushed through compression nozzle 216. As such, the force of the fluid is increased as it exits the narrower output 212.

In one embodiment, compression nozzle 216 is a variable exhaust nozzle, which allows the amplification of the pressure of the exiting fluid to be adjusted. One example of a variable exhaust nozzle is the compression nozzle used on a jet engine. In another embodiment, compression nozzle 216 provides a certain amount of amplification of the pressure of the exiting that is constant.

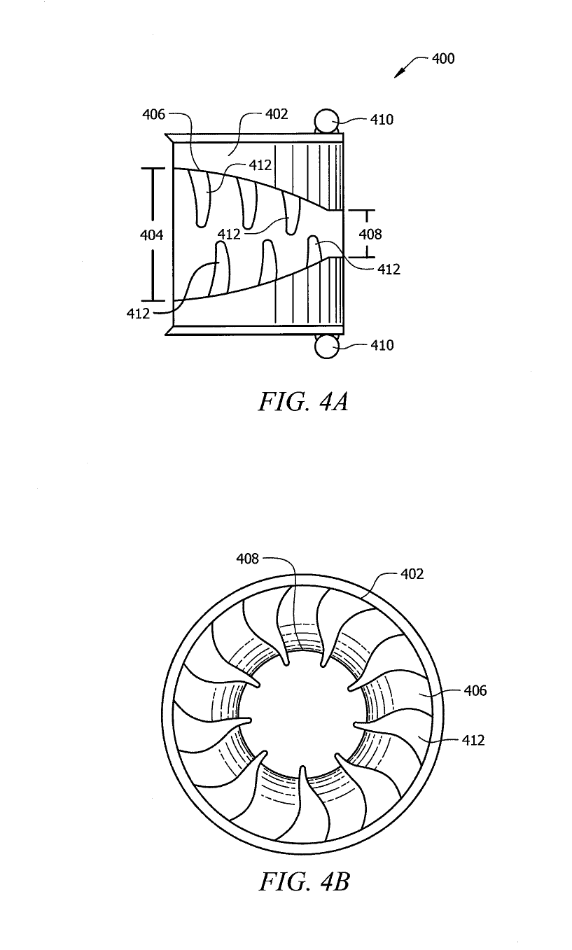

This thrust or increase of the force of the exiting fluid can also be achieved by other means. In one embodiment, the force of the exiting fluid can be amplified through the narrowing of the shaft itself, instead of using a separate thrust component. Referring to FIG. 4A, there is a rotating impeller system 400 with a shaft 402. Attached to the wall of shaft 402 are a plurality of blades 412. As with rotating impeller system 200 of FIGS. 2A-2C, blades 412 may be removably attached to shaft 402 or may be molded into a portion of the wall of shaft 402. In one embodiment, system 400 can comprise blade inserts as discussed above. In the preferred embodiment, shaft 402 is mechanically coupled to a bearing housing (not shown) as discussed above, e.g., via bearings 410. According to the preferred embodiment, shaft 402 is otherwise not in contact with other components of the bearing housing. Shaft 402 preferably rotates freely with respect the bearing housing via the bearings. In one embodiment, the bearings are preferably located near the ends of shaft 402. Suitable bearings include external bearings, ball bearings, roller bearings, or any other type of bearings that allow shaft 402 to freely rotate with respect to the bearing housing.

FIG. 4A shows the portion of shaft 402 near the output that tapers to amplify the force of the exiting fluid. The portion of shaft 402 near the input can be in a similar configuration as the rotating impeller system 200 shown in FIGS. 2A-2C. Referring to FIGS. 4A and 4B, the diameter 404 of shaft 402 is larger toward the input than the diameter 408 at or near the output. When the shaft 402 functions as a motor and rotates when energized, the attached blades 412 rotates and create a driving force that forces fluid around the input of system 400 through shaft 402 and out of the output. As the fluid travels through rotating impeller system 400, it is compressed by the narrowing wall of the shaft 402 toward the output. The ratio between the diameter of the output and the input may be configured to achieve the desired output force.

In another embodiment, the amplified force of the output can be achieved by coupling a series of rotating impeller systems together, where the diameter of the shaft of the rotating impeller systems progressively decreases in size. For instance, in one embodiment, two rotating impeller systems are coupled to one another where the output of the first system is connected to the input of the second system. The rotating impeller systems comprise a shaft that rotates when energized as described with respect to FIGS. 2A-2C. The shaft of the first system has a greater diameter than the shaft of the second system. When both systems are energized, the rotating blades create a driving force that pulls fluid through the shafts of the two systems. The fluid exiting the first system is compressed as it travels through the smaller shaft of the second system. The force of the fluid exiting the first system is amplified by the second system. Accordingly, the fluid exiting the second system has a greater force than the fluid exiting the first system. The number of rotating impeller systems coupled to one another and/or the difference in the diameter of the shafts may be determined by the desired amplified pressure.

In other embodiments, the different ways of creating additional thrust can be combined when increased pressure is desired. For instance, a rotating impeller system with a shaft having a narrowing wall as shown in FIGS. 4A-4B can further comprise a thrust component, such as compression nozzle 216 shown in FIG. 2B. In another embodiment, a device with a series of rotating impeller systems having progressively smaller shafts can further comprise a thrust component, such as nozzle 216 shown in FIG. 2B, and/or the shaft of one or more rotating impeller systems can have narrowing walls. It is envisioned that various combinations of the means for creating additional thrust can be employed to achieve the desired output force.

Motor applications for the rotating impeller system of the present disclosure can include water or other fluid pump, vacuum cleaner, home exhaust fan, etc. Applications for the rotating impeller system of the present disclosure with increased thrust can include leaf blower, electric thrust engine (e.g., aircraft—commercial and models), personal flight suit, blow dryer, air conditioner, heater, etc. The electrical parts allowing the rotating impeller system to be energized are known in the art. Likewise, accessories that assist in directing the movement of the input and/or output (such as collection of leaves or from where water is taken and to where water is provided) are known in the art. Further, these examples merely serve as exemplary applications. The rotating impeller system of the present disclosure can replace any pump or vacuum component in other applications or device, including those that require compressed fluid.

In another embodiment, the rotating impeller system 200 may further comprise a housing (not shown) that covers shaft 202, bearing housing 208, and bearings 206 or 306 completely or partially, depending on the applications. For instance, if rotating impeller system 200 is used in under water applications, the housing for rotating impeller system 200 may substantially cover the body of shaft 202, as well as bearing housing 208, while leaving input 210 and output 212 open. In other embodiments, the housing for rotating impeller system 200 may further be configured to accept accessory attachments.

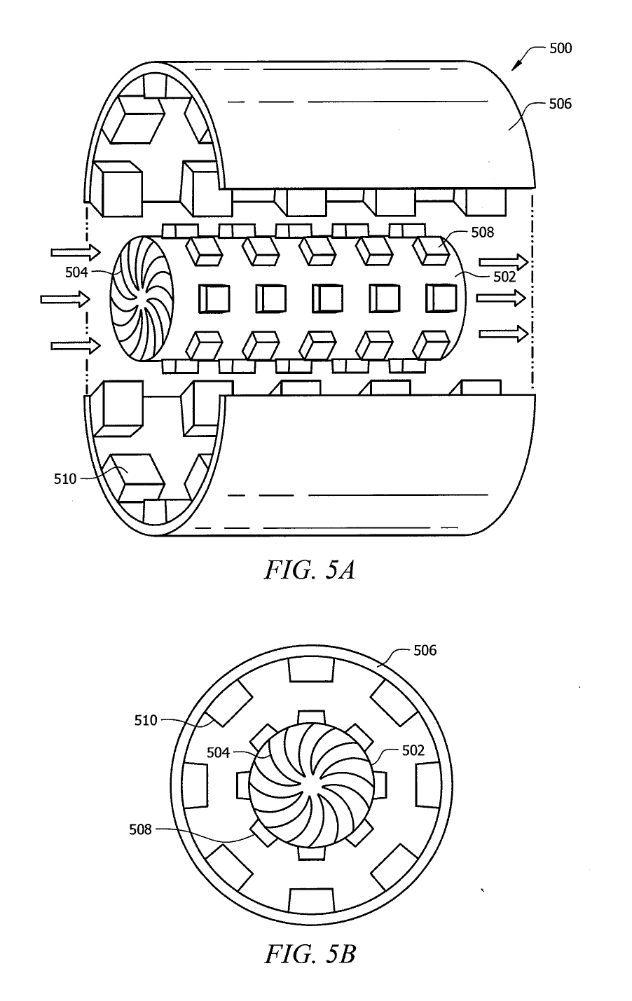

As the rotating impeller system of the present disclosure may be used as a motor, particularly as pumps and vacuums, it can also serve as a generator that harvest the mechanical power, such as that of wind or water, and converts the mechanical energy into electricity. Referring to FIG. 5A, there is rotating impeller system 500 that comprises shaft 502. Attached to the wall of shaft 502 are a plurality of blades 504. As with rotating impeller system 200 of FIGS. 2A-2C, blades 504 may be removably attached to shaft 502 or may be molded into a portion of the wall of shaft 502. In one embodiment, system 500 can comprise blade inserts as discussed above. In the preferred embodiment, shaft 502 and housing 506 are mechanically coupled to one another via bearings (not shown). According to the preferred embodiment, shaft 502 is otherwise not in contact with other components of housing 506. Shaft 502 preferably rotates freely with respect housing 506 via the bearings. In one embodiment, the bearings are preferably located near the ends of shaft 502. Suitable bearings include plain bearings, rolling element bearings, jewel bearings, fluid bearings, magnetic bearings, flexure bearings or any other type of bearings or materials that allow shaft 502 to freely rotate with respect to housing 506.

Housing 506 preferably surrounds shaft 502. In one embodiment, to generate electricity, a plurality of permanent magnets 508 are attached to the outer wall of shaft 502 while a plurality of armature windings 510 are attached to the inner wall of housing 506. Housing 506 serves as the stator while shaft 502 serves as the rotor of a generator. Permanent magnets 508 produce the magnetic field that interact with armature windings 510 to generate electricity. Armature windings 510 are preferably coupled to a electricity storage component that stores the electricity for distribution or immediate use. As the mechanical force, e.g., wind or water, moves through shaft 502 itself, the force acts on blades 504 and rotates shaft 502. This rotation causes the magnetic field produced by magnets 508 to move and interact with armature windings 510, thereby inducing current in the armature that can be transferred away for distribution. Alternatively, instead of permanent magnets, the magnetic field may be created by energized electromagnets. Other known arrangements of magnets and/or electromagnets may be used with the rotating impeller system of the present disclosure. Shaft 502 performs both the electrical and mechanical functions, thereby eliminating the conventional input shaft configuration. Accordingly, the present disclosure provides a single component serving as both a mechanical mechanism for accepting a driving force and an electrical mechanism for translating the driving force to electricity.

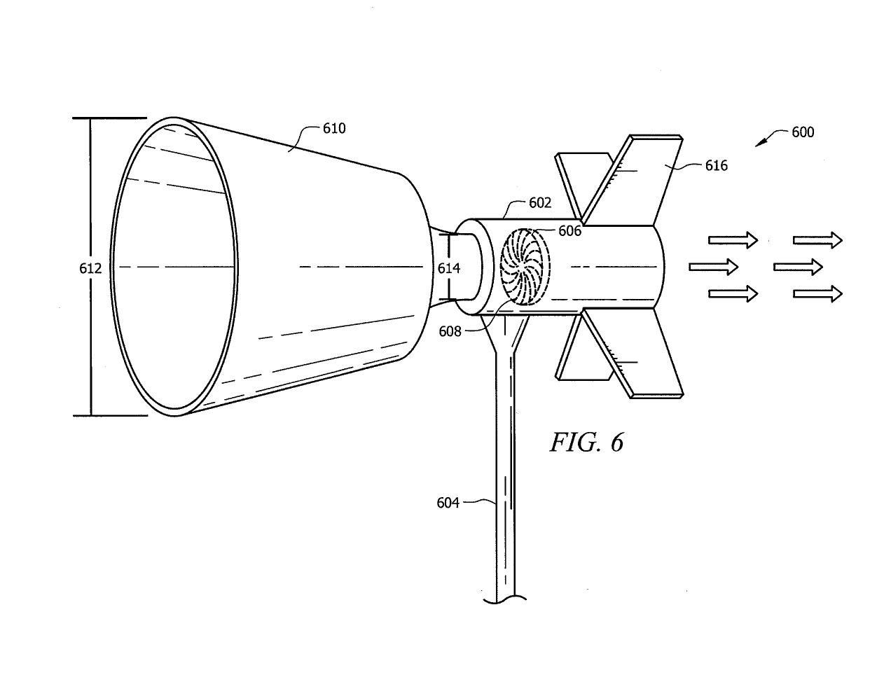

The generator applications of the rotating impeller system of the present disclosure are particularly applicable to harvest wind and water energy. For instance, referring to FIG. 6, wind generator system 600 includes rotating impeller system 602 that is mounted on pole 604 that allows rotating impeller system 602 to fully rotate 360 degrees. Rotating impeller system 602 contains similar components as rotating impeller system 500 described with respect to FIGS. 5A-5B. For instance, rotating impeller system 602 has shaft 606 with a plurality of blades 608 attached to the inner wall of shaft 606. Rotating impeller system 602 comprises a housing that surrounds shaft 606. Shaft 606 and the housing are mechanically coupled to one another via bearings. There are permanent magnets or electromagnets attached to the outer wall of shaft 606, and there are armature windings attached to the inner wall of the housing.

Wind generator system 600 further includes induction cone 610 attached to the input of rotating impeller system 602. In the preferred embodiment, induction cone 610 is a separate component that is attached to the housing of rotating impeller system 602. In one embodiment, induction cone 610 is removably attached. In another embodiment, induction cone 610 is part of the housing of rotating impeller system 602 (e.g., molded to a portion of the housing). Preferably, induction cone 610 is attached so that it does not rotating with shaft 606 when the wind acts on blades 608 and rotates shaft 606. According to the preferred embodiment, induction cone 610 is coupled to rotating impeller system 602 so that no air escapes system 600 prior to entering rotating impeller system 602. One way of preventing air from escaping is to provide a seal between induction cone 610 and rotating impeller system 602.

Induction cone 610 preferably has input diameter 612 that is larger than output diameter 614 near the input of the rotating impeller system 602. The ratio between the input diameter 612 and the output diameter 614 depends on the operating conditions of the particular wind generator 600. In one embodiment, the ratio between the input diameter 612 and the output diameter 614 is about 3:1. The generally conical shape of induction cone 610 reduces the turbulence of the incoming wind and amplifies the wind force entering rotating impeller system 602, providing an increased force that acts on blades 608 and rotates shaft 606. To achieve optimal harvest of wind energy, the wind generator system 600 preferably further comprises tail component 616 that allows wind generator system 600 to follow and harvest the wind as it changes direction. As with other wind energy systems, a plurality of the wind generator systems 600 may be placed near one another in an arrangement that maximizes capturing of the wind energy. The plurality of wind generator systems 600 are connected to transformers that collect the generated electricity for distribution.

In another embodiment, wind generator 600 is electrically coupled to a battery of a vehicle and is located on the vehicle in a manner that allows wind generator 600 to receive wind force and generate electricity that is stored in the vehicle battery. The vehicle can use the energy from the battery to move the vehicle itself and/or to power certain parts of the vehicle, such as lights and radio. When wind—whether from the movement of the vehicle or otherwise, acts on blades 608, shaft 606 is rotated, which generates electricity in the armature windings attached to the inner wall of the housing of rotating impeller system 602. The generated electricity is transferred to the electrically coupled battery in the associated vehicle. This battery can be the primary battery of the vehicle or a secondary battery that stores this generated electricity for later usage. In certain embodiments, wind generator 600 may not include induction cone 610 and/or tail component 616, depending on the application and/or any size requirements.

The rotating impeller system of the present disclosure is also particularly applicable to hydroelectricity. For instance, one or more of the rotating impeller systems of the present disclosure, as described in FIGS. 5A and 5B, may be placed in or under waterfalls or dams to receive the falling water that acts on the blades connected to the inner wall of the shaft of the impeller system and turns the shaft to generate electricity. Also, one or more of the rotating impeller systems, as described in FIGS. 5A and 5B, of the present disclosure may be placed in the ocean to harvest the energy of the ocean currents. The rotating impeller system of the present disclosure may be attached to a buoyant member that keeps the rotating impeller system within a desired depth range. The buoyant member allows the rotating impeller system to rotate 360 degrees to optimally capture the energy of the currents as the current direction changes. The rotating impeller system can also be attached an anchor to keep in a desired arrangement. As with other hydroelectricity systems, a plurality of the rotating impeller systems harvesting energy from water may be connected to a transformer or other electrical storage component that collects the generated electricity for distribution.

Although the present invention and its advantages have been described in detail, it should be understood that various changes, substitutions and alterations may be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A motor comprising:
a bearing housing member;
a-shaft member configured to rotate when energized ;
a plurality of blade members attached to the inner wall of said shaft member; and
a plurality of bearing members mounted between at least one end of said shaft member and said bearing housing member to allow said shaft member to rotate with respect to said bearing housing member.

2. The motor of claim 1 further comprising:
a thrust member attached to an input of said shaft member;
wherein said thrust member comprises an input having a first diameter and an output having a second diameter, where said first diameter differs from said second diameter.

3. The motor of claim 1 wherein said shaft member comprises an input having a first diameter and an output having a second diameter, where said first diameter is greater than said second diameter.

4. The motor of claim 1 wherein said plurality of bearing members are selected from the group consisting of plain bearings, rolling element bearings, jewel bearings, fluid bearings, magnetic bearings and flexure bearings.

5. A generator system comprising:
a mechanical element configured to accept a mechanical action; and
an electrical element configured to translate said mechanical action into electrical energy;
wherein said mechanical element and electrical element comprise a single component.

6. The system of claim 5 wherein said mechanical element is axially aligned with said electrical element.

7. The system of claim 5 wherein said single component is configured to rotate in response to said accepting a mechanical action.

8. The system of claim 5 wherein said mechanical element is circumferentially inside of said electrical element.

9. The system of claim 5 wherein said mechanical element comprises a plurality of blade members.

10. The system of claim 5 further comprising an induction component, wherein said induction component is configured to amplify fluid entering said single component.

11. The system of claim 10 wherein said induction component comprises a first diameter and a second diameter, wherein said first diameter is greater than said second diameter.

12. A motor system comprising:
a single component configured to rotate and produce a driving force when energized,
wherein said single component comprises a mechanical element configured to produce said driving force when rotated; and an electrical element configured to energize said mechanical element using electrical energy.

13. The system of claim 12 wherein said mechanical element is axially aligned with said electrical element.

14. The system of claim 12 wherein said mechanical element is circumferentially inside of said electrical element.

15. The system of claim 12 wherein said mechanical element comprises a plurality of blade members.

16. The system of claim 12 further comprising a thrust component, wherein said thrust component is configured to amplify fluid exiting said single component.

17. The system of claim 16 wherein said thrust component comprises a first diameter and a second diameter, wherein said first diameter is greater than said second diameter.

18. The system of claim 17 wherein an input of said thrust component comprises said first diameter and an output of said thrust component comprises said second diameter.

19. The system of claim 18 wherein the input of said thrust component is coupled to an output of said single component.

20. The system of claim 12 wherein said single component is configured to amplify fluid exiting said single component, said amplification achieved by said electrical element comprising a first diameter and a second diameter, wherein said first diameter is greater than said second diameter.
